(19) United States
(12) Patent Application Publication
(10) Pub. No.: US 2019/0139162 A1
(43) Pub. Date: May 9, 2019

(54) INFORMATION PROVIDING SYSTEM AND INFORMATION PROVIDING METHOD FOR CHARGING STATION, AND SERVER FOR THE SAME

(71) Applicant: TOYOTA JIDOSHA KABUSHIKI KAISHA, Toyota-shi (JP)

(72) Inventors: Hiroki SAWADA, Toyota-shi (JP); Masato TAMAOKI, Iwakura-shi (JP); Eisuke ANDO, Nagoya-shi (JP); Masato ENDO, Nagakute-shi (JP); Kuniaki HASEGAWA, Kariya-shi (JP)

(73) Assignee: TOYOTA JIDOSHA KABUSHIKI KAISHA, Toyota-shi (JP)

(21) Appl. No.: 16/183,247

(22) Filed: Nov. 7, 2018

(30) Foreign Application Priority Data
Nov. 9, 2017 (JP) 2017-216425

(51) Int. Cl. G06Q 50/06; G06Q 10/02; G06Q 30/02; B60L 11/18

(52) U.S. Cl. CPC G06Q 50/06; G06Q 10/02; B60K 6/28; B60L 11/1838; B60L 2230/16; G06Q 30/0259

(57) ABSTRACT

An information providing system includes a plurality of charging stations, a vehicle equipped with a power storage device, and a management server. The vehicle may charge the power storage device by using electric power supplied from the charging station. The management server may communicate with the vehicle and the plurality of charging stations. The vehicle sends information about a destination designated by a user to the management server. Upon receiving the information about the destination from the vehicle, the management server acquires congestion information indicating a congestion degree of a charging station installed in the destination among the plurality of charging stations and incentive information from a charging station installed around the destination among the plurality of charging stations, and sends the information to the vehicle. The vehicle displays the information sent from the management server to the user.

This non-provisional application is based on Japanese Patent Application No. 2017-216425 filed on Nov. 9, 2017 with the Japan Patent Office, the entire contents of which are hereby incorporated by reference.

### BACKGROUND

### Field

The present disclosure relates to an information providing system and an information providing method for a charging station and a server for the same, and more specifically, relates to a technique providing information for the purpose of alleviating a congestion degree of a charging station installed in a destination designated by a user.

### Description of the Background Art

In recent years, as an environmentally-friendly vehicle, an electrically powered vehicle (such as a plug-in hybrid vehicle or an electric vehicles) capable of charging a power storage device mounted thereon by using electric power from a power source external to the vehicle is becoming widespread. When such an electrically powered vehicle is parked in a parking lot of a destination such as a shopping center or a movie theater, it may be necessary to charge the power storage device at a charging station installed in the destination. If the parking lot and the charging station in the destination are congested, a longer waiting time is required.

Japanese Patent Laying-Open No. 2016-218647 discloses a system that predicts the congestion degree of a charging spot (charging station) based on an expected charging rate of an electrically powered vehicle as it arrives at the charging spot, and presents the congestion degree to the user of the electrically powered vehicle.

### SUMMARY

The system disclosed in Japanese Patent Laying-Open No. 2016-218647 determines the congestion degree of each charging station adjacent to a scheduled traveling route of a vehicle at the time as the vehicle arrives at the charging station based on the expected charging rate and the stop-by rate of the other vehicles as they arrive at the same charging station. As a result, the user may select a charging station having a lower congestion degree along the scheduled traveling route, which makes it possible to charge the power storage device at a shorter waiting time.

According to Japanese Patent Laying-Open No. 2016-218647, the charging may be performed at any charging station adjacent to the scheduled traveling route as long as it is within a travelable distance of the vehicle, and thus, any charging station may be selected based on its congestion degree.

However, when a user is planning to charge at a certain destination (for example, a shopping center or a theme park), it is highly possible that the user wishes to charge at a charging station installed in the destination. Thus, the congestion degree of the charging station (and the parking lot) may become higher, which may further lengthen the waiting time. As a result, the user may not be able to charge the vehicle during the period of staying at the destination.

The present disclosure has been made to solve the aforementioned problems, and an object of the present disclosure is to alleviate the congestion degree of a charging station installed in a destination designated by a user so as to provide the user an opportunity to charge the vehicle during the period of staying at the destination.

An information providing system according to the present disclosure includes a plurality of charging stations configured to supply electric power, a vehicle equipped with a power storage device and configured to charge the power storage device by using the electric power supplied from the charging station, and a server configured to communicate with the vehicle and the plurality of charging stations. The vehicle sends information about a destination designated by a user to the server. Upon receiving the information about the destination from the vehicle, the server acquires congestion information indicating a congestion degree of a charging station installed in the destination from the same charging station among the plurality of charging stations and incentive information for prompting charging at a charging station installed around the destination from the same charging station among the plurality of charging stations and sends the information to the vehicle. The vehicle displays the information sent from the server to the user.

With such a configuration, after designating a destination, the user may grasp the congestion information about the charging station installed in the destination, and may obtain the information about an available charging station installed around the destination along with its incentive information. Thus, the use may avoid charging at the charging station installed in the destination which is congested, and turn to use a charging station installed around the destination. Therefore, it is possible to alleviate the congestion degree of the charging station installed in the destination designated by the user so as to provide the user an opportunity to charge the vehicle during the period of staying at the destination.

The server sends the congestion information and the incentive information to the vehicle when the congestion degree of the charging station installed in the destination is greater than a threshold value.

When the first desire of the user is to charge the vehicle at the destination, it is unlikely that the user may select a charging station installed around the destination. Therefore, when the congestion degree of a charging station installed in the destination is low, it is possible to prioritize the user's first desire by providing only the information about the charging station installed in the destination.

The incentive information includes information about a discount service provided by a charging station installed around the destination.

The discount service includes a discount on unit price of power or a discount on parking fee.

The charging station installed around the destination includes a charging station installed in a store. The discount service includes a discount on prices of goods and charges of services provided by the store.

By providing the discount on unit price of power, the discount of parking fee or the discount of prices of goods and charges of services provided by the store as the incentive information, it is highly possible that the user is urged to charge at a charging station installed around the destination.

The vehicle is provided with a display for displaying the information from the server and an input device. The user uses the input device to select a desired charging station from charging station candidates included in the displayed information from the server. When a desired charging station is selected by the user from the charging station candidates, the vehicle sends information for specifying the selected charging station to the server. The server sends a charging reservation request to the selected charging station.

The charging reservation request includes information about the vehicle and an estimated time of arrival to the selected charging station. The selected charging station processes the charging reservation from the vehicle according to the charging reservation request.

With such a configuration, it is possible to easily make a charging reservation for a desired charging station based on the information provided from the server about the charging station.

An information providing method according to another aspect of the present disclosure is used in a system including a plurality of charging stations, a vehicle equipped with a power storage device and a server for providing information about a charging station to a user of the vehicle. The vehicle and the plurality of charging stations are configured to communicate with the server, and the vehicle is configured to charge the power storage device by using electric power from a charging station. The method includes steps of (a) causing the server to acquire from the vehicle information about a destination designated by a user's operation on the vehicle, (b) causing the server to acquire congestion information indicating a congestion degree of a charging station installed in the destination from the same charging station among the plurality of charging stations and incentive information for prompting charging at a charging station installed around the destination from the same charging station among the plurality of charging stations, (c) causing the server to send the congestion information and the incentive information to the vehicle, and (d) causing the vehicle to display the information sent from the server to the user.

A server according to still another aspect of the present disclosure is configured to communicate with a vehicle equipped with a power storage device and a plurality of charging stations, and provide information about a charging station to a user of the vehicle. The server is configured to acquire information about a destination designated by a user's operation on the vehicle, acquire congestion information indicating a congestion degree of a charging station installed in the destination from the same charging station among the plurality of charging stations and incentive information for prompting charging at a charging station installed around the destination from the same charging station among the plurality of charging stations, and send the congestion information and the incentive information to the vehicle so as to be displayed to the user.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating the overall configuration of an information providing system according to an embodiment of the present disclosure;

FIG. 2 is a diagram for explaining the configuration for charging an electrically powered vehicle by using the electric power supplied from a charging station in FIG. 1;

FIG. 3 is a block diagram illustrating the configuration of a navigation device provided in the electrically powered vehicle of FIG. 2;

FIG. 4 is a block diagram illustrating the configuration of an integrated controller of the charging station in FIG. 2;

FIG. 5 is a block diagram illustrating the configuration of a management server;

FIG. 6 is a sequence diagram illustrating a process executed by each element of the information providing system according to an embodiment of the present disclosure;

FIG. 7 is a diagram illustrating an example of information displayed on the electric powered vehicle; and

FIG. 8 is a flowchart for explaining the details of controls executed by the information providing system according to an embodiment of the present disclosure.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

<Configuration of System>

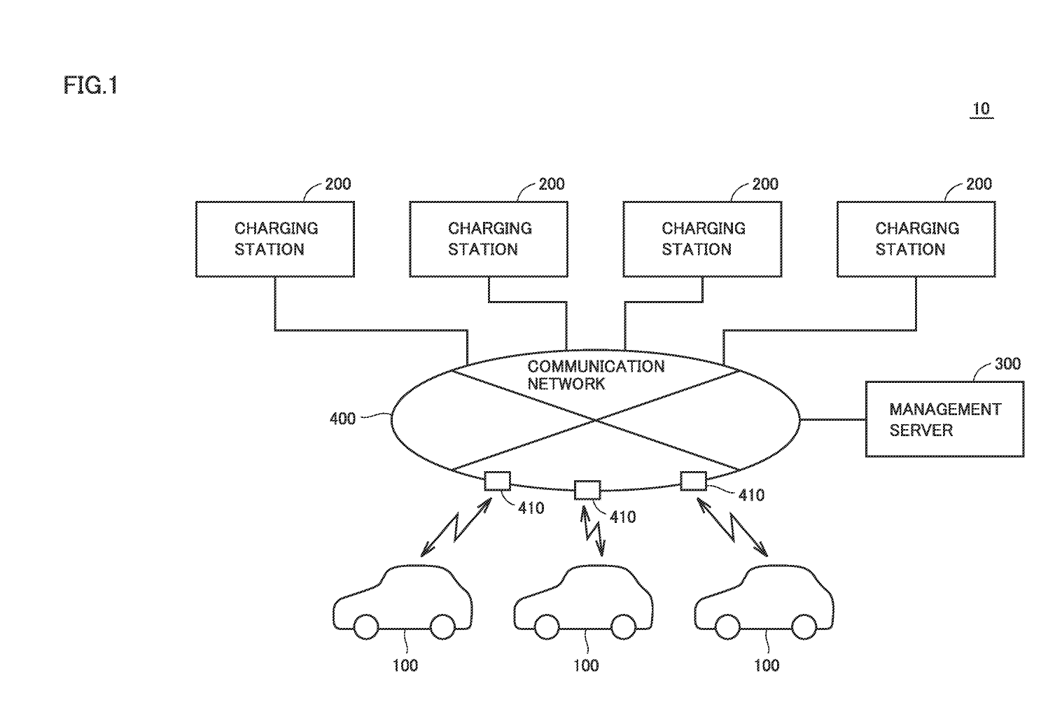

FIG. 1 is a diagram schematically illustrating the overall configuration of an information providing system 10 according to an embodiment of the present disclosure. With reference to FIG. 1, the information providing system 10 includes a plurality of electrically powered vehicles (hereinafter simply referred to as “vehicle”) 100, a plurality of charging stations 200, and a management server 300. The vehicle 100, the charging station 200 and the management server 300 are configured to communicate with each other via a communication network 400 such as the Internet or a telephone line. Each vehicle 100 is configured to exchange information via wireless communication with a base station 410 of the communication network 400. Note that the vehicle 100, the charging station 200 and the management server 300 may directly communicate with each other without the mediation of the communication network 400.

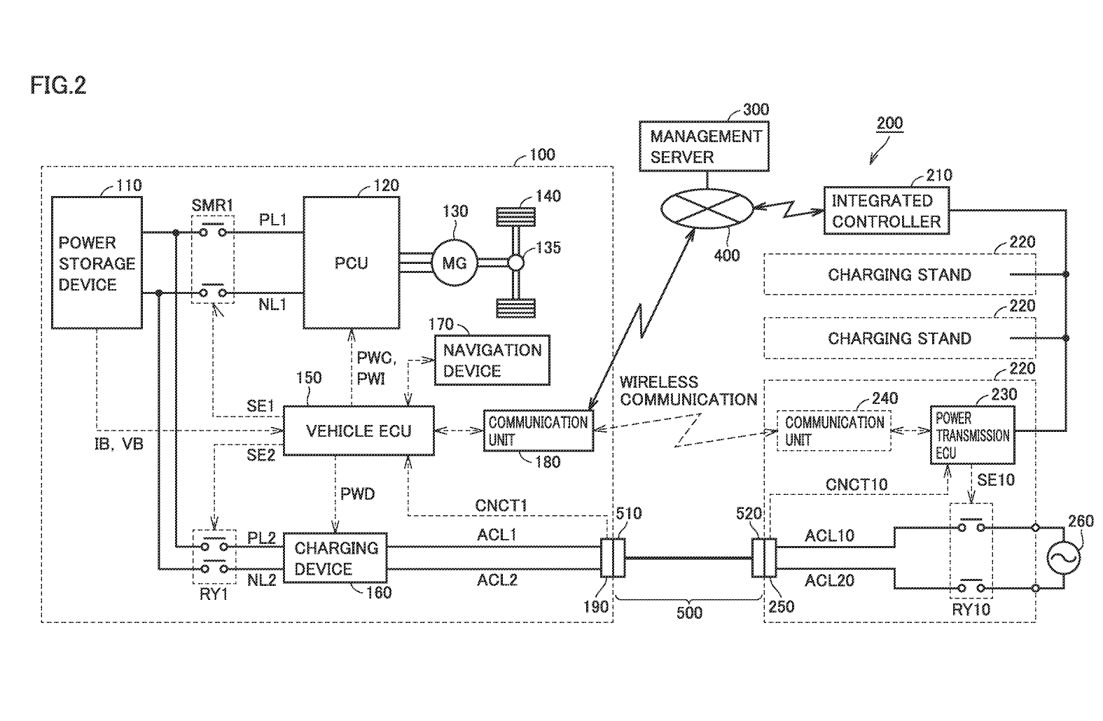

As will be described later with reference to FIG. 2, the vehicle 100 is configured to use electric power from a mounted power storage device to generate a driving force for traveling, and use electric power supplied from a power source external to the vehicle to charge the power storage device. The vehicle 100 may be, for example, an electric vehicle or a plug-in hybrid vehicle.

The charging station 200 is a power supplying facility for supplying electric power to the vehicle 100. The charging station 200 may be installed in a parking lot of a shopping center, for example.

The management server 300 communicates with the vehicle 100 and the charging station 200, and provides the information about the charging station 200 to the vehicle 100.

FIG. 2 is a diagram for explaining the configuration for charging the vehicle 100 by using electric power supplied from the charging station 200 in FIG. 1.

With reference to FIG. 2, the vehicle 100 includes a power storage device 110, a system main relay SMR1, a PCU 120 as a drive device, a motor generator 130, a power transmission gear 135, driving wheels 140, a vehicle ECU (Electronic Control Unit) 150, and a navigation device 170.

The charging station 200 includes an integrated controller 210 and one or more charging stands 220. Each charging stand 220 includes a power transmission ECU 230, a communication unit 240, a connector 250, and a relay RY10.

The integrated controller 210 is connected to the communication network 400 wirelessly or by wire, and is configured to communicate with the management server 300. Further, the integrated controller 210 may communicate with the power transmission ECU 230 of each charging stand 220 so as to integrally control one or more charging stands 220.

The power transmission ECU 230 is such a control unit that controls power transmission in each charging stand 220. Note that the functions of the power transmission ECU 230 may be performed by the integrated controller 210, and in that case, the power transmission ECU 230 may not be provided in each charging stand.

The charging stand 220 includes a relay RY10 provided across a pair of power lines ACL10 and ACL20 which connect the connector 250 with an external power source 260. A plug 520 of a charging cable 500 is connected to the connector 250 so as to supply the electric power from the charging stand 220 to the vehicle 100 via the charging cable 500. The relay RY10 is configured to switch the initiation or interruption of the supply of the electric power from the external power source 260 to the charging cable 500 based on a control signal SE10 from the power transmission ECU 230.

The communication unit 240 is a communication interface that is configured to provide communication between the power transmission ECU 230 and the vehicle ECU 150 provided in the vehicle 100 so as to exchange signals with a communication unit 180 provided in the vehicle 100 via wireless communication. Note that if communication with the vehicle 100 is performed by using the charging cable 500 or is performed by the integrated controller 210, the communication unit 240 may not be provided.

The power storage device 110 mounted on the vehicle 100 is a chargeable/dischargeable electric power storing element. The power storage device 110 may include, for example, a secondary battery such as a lithium ion battery or a nickel hydrogen battery, or a power storage element such as an electric double layer capacitor.

The power storage device 110 is connected via the system main relay SMR1 to the PCU 120 for driving the motor generator 130. The power storage device 110 supplies the electric power to the PCU 120 so as to generate a driving force for the vehicle 100. In addition, the power storage device 110 stores the electric power generated by the motor generator 130. The power storage device 110 outputs to the vehicle ECU 150 a voltage VB and a current IB of the power storage device 110 which are detected by a sensor (not shown).

The system main relay SMR1 includes a relay connected between a positive terminal of the power storage device 110 and a power line PL1 of the PCU 120 and a relay connected between a negative terminal of the power storage device 110 and a power line NL1. The system main relay SMR1 is configured to switch the initiation or interruption of the supply of the electric power between the power storage device 110 and the PCU 120 based on a control signal SE1 from the vehicle ECU 150.

Although not illustrated in the figure, the PCU 120 includes a power conversion device such as a converter and an inverter. The converter and the inverter are controlled respectively by control signals PWC and PWI from the vehicle ECU 150 so as to convert a DC power from the power storage device 110 into an AC power for driving the motor generator 130.

The motor generator 130 is an AC rotating motor such as a permanent-magnet synchronous motor provided with a rotor in which permanent magnets are buried. The output torque of the motor generator 130 is transmitted to the driving wheels 140 via the power transmission gear 135 composed of a speed reducer and a power split mechanism so as to drive the vehicle 100 to travel. During regenerative braking operation of the vehicle 100, the motor generator 130 may generate electric power from the rotational force of the drive wheels 140. The generated electric power is converted by the PCU 120 into the charging power for charging the power storage device 110.

Further, in a hybrid vehicle equipped with an engine (not shown) in addition to the motor generator 130, the engine and the motor generator 130 work cooperatively to generate a driving force required by the vehicle. In this case, it is also possible to charge the power storage device 110 by using the electric power generated from the rotation of the engine.

Although not illustrated in FIG. 2, the vehicle ECU 150 includes a CPU (Central Processing Device), a memory and an input/output buffer, and is configured to receive an input signal from a sensor or the like and send a control signal to each device so as to control the vehicle 100 and each device. Note that such control is not limited to be performed by software, it may be performed by a dedicated hardware (an electronic circuit).

The vehicle ECU 150 outputs control signals for controlling the PCU 120, the system main relay SMR1 and the like. Further, the vehicle ECU 150 receives the voltage VB and the current IB from the power storage device 110. Based on these data, the vehicle ECU 150 calculates the state of charge (hereinafter also referred to as “SOC”) of power storage device 110.

The vehicle 100 further includes a communication unit 180, a charging device 160, an inlet 190, and a charging relay RY1 as a configuration for charging the power storage device 110 with the electric power supplied from the charging station 200.

The inlet 190 is connected by a charging connector 510 of the charging cable 500. Thus, the electric power supplied from the charging station 200 is transmitted to the vehicle 100 via the charging cable 500. The inlet 190 is provided with a sensor (not shown) for detecting that the charging connector 510 is connected to the inlet 190, and a connection signal CNCT1 detected by the sensor is output to the vehicle ECU 150.

The charging device 160 is connected to the power storage device 110 by a pair of power lines PL2 and NL2 with a charging relay RY1 interposed therebetween. The charging relay RY1 is controlled by a control signal SE2 from the vehicle ECU 150 so as to switch the initiation or interruption of the supply of the electric power between the power storage device 110 and the charging device 160. Further, the charging device 160 is connected to the inlet 190 by a pair of power lines ACL1 and ACL2. The charging device 160 is controlled by a control signal PWD from the vehicle ECU 150 so as to convert an AC power supplied from the charging station 200 into a DC power that may be used to charge the power storage device 110.

The communication unit 180 is a communication interface that is configured to provide communication between the vehicle ECU 150 and the power transmission ECU 230 so as to exchange signals with the communication unit 240 provided in the charging station 200 via wireless communication. Further, the communication unit 180 is configured to communicate with the management server 300 via the communication network 400 as described above.

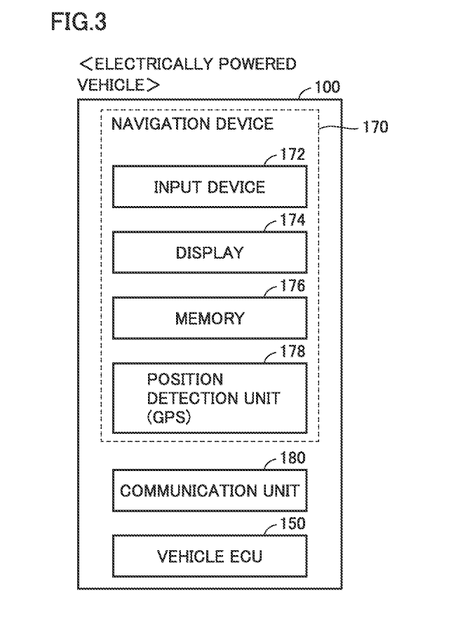

As illustrated in FIG. 3, the navigation device 170 includes an input device 172, a display 174, a memory 176, and a position detection unit 178. Based on the map information stored in the memory 176 and the position information of the vehicle 100 detected by a GPS (Global Positioning System) of the position detection unit 178, the navigation device 170 displays the current position of the vehicle 100 on map and/or provides the user a guidance to the destination.

The display 174 is composed of, for example, a liquid crystal panel, and is configured to display the current position of the vehicle 100 or various information from the vehicle ECU 150. The input device 172 is composed of a touch panel, a switch and the like, and configured to accept an operation by a user.

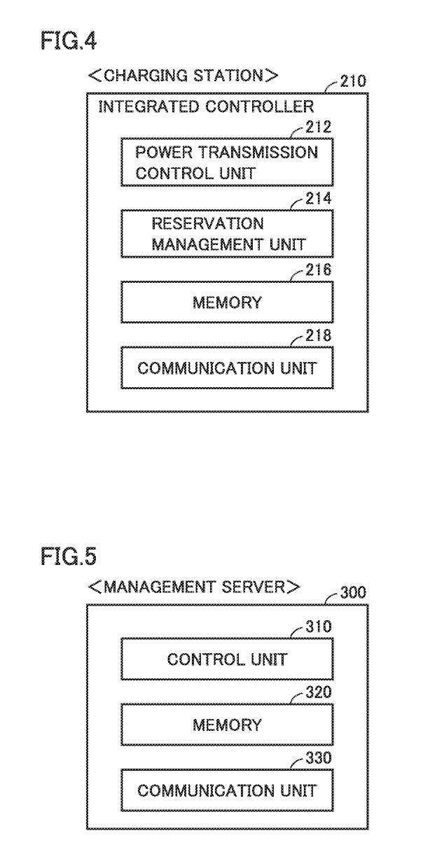

FIG. 4 is a block diagram illustrating the configuration of the integrated controller 210 provided in the charging station 200. With reference to FIG. 4, the integrated controller 210 includes a power transmission control unit 212, a reservation management unit 214, a memory 216, and a communication unit 218.

The reservation management unit 214 formulates a charging schedule based on the reservation request received from the vehicle 100 via the management server 300, and stores the charging schedule in the memory 216.

The power transmission control unit 212 controls the power transmission operation in each charging stand 220. Specifically, the power transmission control unit 212 reads the charging schedule formulated by the reservation managing device 214 from the memory 216, and instructs the charging stand 220 to execute an actual power transmission operation.

The communication unit 218 is a communication interface for exchanging information with the management server 300 and the vehicle 100 via the communication network 400. In addition, the communication unit 218 may communicate with the vehicle 100 directly.

FIG. 5 is a block diagram illustrating the configuration of the management server 300. With reference to FIG. 5, the management server 300 includes a control unit 310, a memory 320, and a communication unit 330.

The communication unit 330 is a communication interface for exchanging information with the vehicle 100 and the charging station 200 via the communication network 400. Based on the information received from the vehicle 100 via the communication unit 330, the control unit 310 collects information such as usage status from the charging station 200, edits the information, and sends the information to the vehicle 100.

The memory 320 is stored with map information and basic information (such as the position information and the numbers of charging stands) of each charging station 200. Based on the information stored in the memory 320, the control unit 310 selects a charging station as a target for information collection.

<Provision of Information of Charging Station>

For example, at holidays, lots of visitors will cluster at shopping centers, movie theaters or theme parks, making the parking lot of such facility congested, and thereby, it may be difficult to charge at the charging station installed in the parking lot of the facility.

When the charging station installed in the destination is congested, even if the user wishes to charge the vehicle during the period of staying at the destination, it will take a long time until the charging station is empty, or the user may have to park in a parking space where charging is impossible.

Consequently, the staying time at the destination may be shortened or the amount of power required to return home may not be secured sufficiently.

Therefore, in the present embodiment, when the charging station installed in the destination designated by the user is congested, an information providing system is adopted so as to provide the user another charging station available around the destination together with the incentive information for prompting charging at the another charging station. With such a system, in order to take the benefit of the received incentive information, it is highly possible that the user may charge at the another charging station available around the destination even if it is a little far away from the destination. Thereby, it is possible to alleviate the congestion degree of the charging station installed in the destination so as to provide the user an opportunity to charge the vehicle during the period of staying at the destination.

In the present specification, the wording of “a charging station installed in the destination” means that the charging station is installed adjacent to the destination. In other words, the charging station may not be necessarily installed in the same premises as the destination, or it may not be operated by the same administrator.

Hereinafter, the details of a control process performed by the information providing system of the charging station according to an embodiment of the present disclosure will be described.

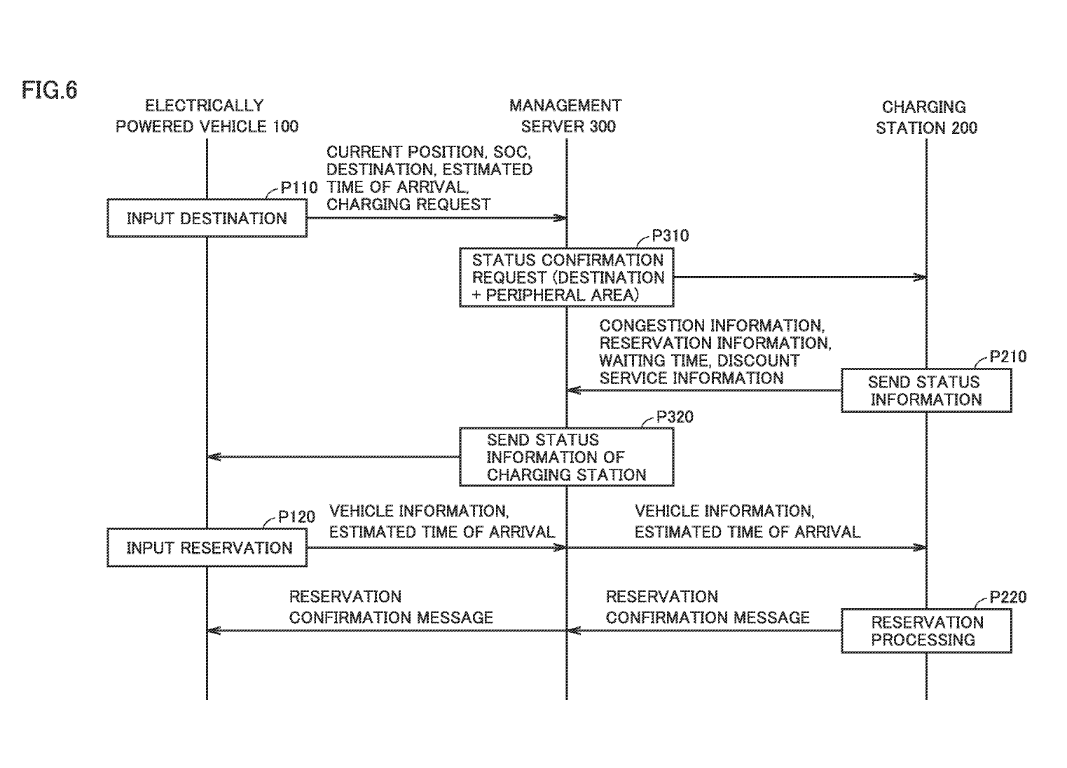

FIG. 6 is a sequence diagram illustrating a process executed by each element of the information providing system 10 according to an embodiment of the present disclosure.

With reference to FIG. 6, when a user of the vehicle 100 inputs to the navigation device 170 that he/she wishes to visit a destination and wishes to charge at the destination (P110), the vehicle 100 sends destination information including the current position, the SOC, the destination, an estimated time of arrival to the destination, and a charging request of the vehicle 100 to the management server 300.

Upon receiving the destination information from the vehicle 100, the management server 300 sends an inquiry about the current usage status and predicted future usage status to the charging station 200 installed in the destination designated by the user of the vehicle 100 (P310). Further, the management server 300 sends an inquiry about the usage status to the other charging stations 200 installed around the destination (for example, within a radius of 5 km from the destination).

Upon receiving the inquiry from the management server 300, each charging station 200 sends the status information such as the current congestion information, the reservation information and the waiting time back to the management server 300 (P210). In addition to the information mentioned above, incentive information is further sent from the charging station 200 installed around the destination. The incentive information includes a discount service or the like that the user may enjoy when the user charges at the charging station 200 installed around the destination instead of the charging station installed in the destination.

Upon receiving the status information and the like from each charging station 200, the management server 300 edits these pieces of information and sends them to the vehicle 100 (P320). The management server 300 may determine whether or not to send the information of a charging station 200 installed around the destination to the vehicle 100 based on the congestion degree of the destination. In the present specification, the term of “congestion degree” is intended to include not only the current congestion degree but also the predicted future congestion degree. The information of a charging station 200 installed around the destination may be sent to the vehicle 100 only when the congestion degree such as a predicted utilization rate several hours ahead of the present time or the waiting time to the start of charging is greater than a predetermined threshold value. Since the first desire of the user is to charge at the charging station 200 installed in the destination, if the charging at the destination is possible, the user's first desire will be prioritized.

It should be noted that while the operation of P110 is being performed in the vehicle 100, the vehicle 100 may send information indicating whether or not the user desires to receive the information about a charging station installed around the destination to the management server 300, and accordingly, the management server 300 may determine whether or not to send such information back to the vehicle 100.

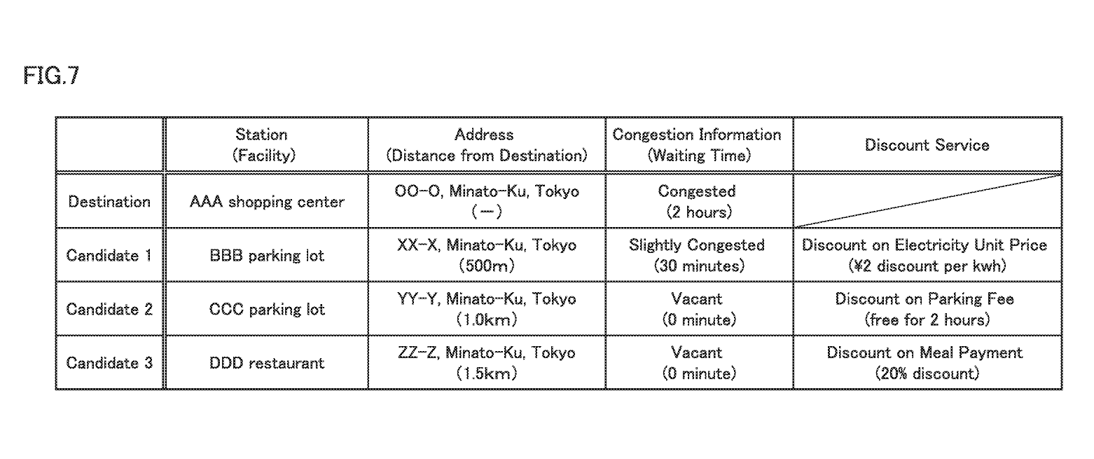

Upon receiving the information about the charging station 200 from the management server 300, the vehicle 100 displays the information on the screen of the navigation device 170. FIG. 7 illustrates an example of the information displayed on the navigation device 170 of the vehicle 100. FIG. 7 lists up the installation position, the position information (the address and the distance from the destination), and the current congestion degree (the waiting time) of a charging station 200 installed in the destination and a charging station 200 installed around the destination, respectively. Further, the information (incentive information) about a discount service that the user may benefit when he/she charges at a charging station 200 installed around the destination is also displayed.

The discount service includes a discount on unit price of charging power, a discount on parking fee for a parking lot to be used or the like. In addition, if a charging station 200 is installed in a store, the discount service may be a discount on price for a product sold at the store or a discount on charges of a service provided by the store. Alternatively, the discount service may be a point-up of service points, a rebate of a predetermined amount of money, a coupon that may be used at any affiliated store or the like.

It is not limited that the discount service is offered by the manager of a parking lot, a charging station and a store (hereinafter also referred to as “manager of a parking lot or the like”), it may be offered, for example, by an organization such as a municipality or a highway public corporation promoting for the alleviation of the traffic congestion (hereinafter also referred to as “municipality or the like”). In addition, the discount service may be offered by both the manager of a parking lot or the like and the municipality or the like.

As such, by providing the congestion information and the incentive information to the user, it is possible to urge the user to charge at a charging station installed around the destination so as to alleviate the congestion degree of the charging station 200 installed in the destination.

Referring again to FIG. 6, when the information about charging stations 200 is displayed in the vehicle 100, the user may select a charging station 200 that he/she wishes to use as needed and reserve the charging station 200. In response to the selection made by the user, the vehicle 100 sends, to the selected charging station 200 via the management server 300, a charging reservation request including the information (user name, ID number and the like) of the vehicle 100, the information for specifying the selected charging station and the estimated time of arrival to the selected charging station.

Upon receiving the charging reservation request from the vehicle 100, the charging station 200 processes the charging reservation request from the vehicle 100 at the reservation management unit 214 (FIG. 4). Upon completion of the reservation processing, the charging station 200 sends a reservation confirmation message to the vehicle 100 via the management server 300 (P220).

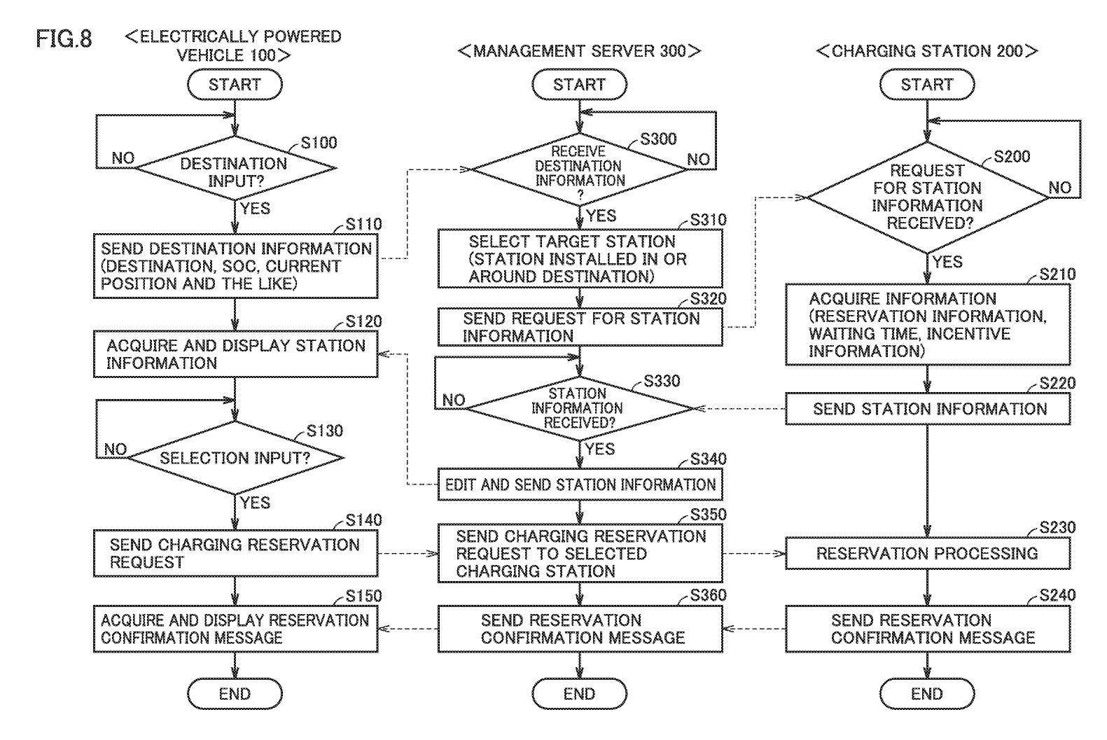

FIG. 8 is a flowchart for explaining the details of a process executed in each of the vehicle 100, the charging station 200, and the management server 300. Specifically, the vehicle ECU 150 is responsible for the process executed in the vehicle 100, the integrated controller 210 is responsible for the process executed in the charging station 200, and the control unit 310 is responsible for the process executed in the management server 300.

With reference to FIG. 8, firstly, the process executed in the vehicle 100 will be described. The vehicle 100 determines whether a destination and a charging request at the destination have been input by the user at step 100 (hereinafter, “step” will be abbreviated as “S”). If there is no input from the user (NO at S100), the process returns to S100 and waits for an input from the user.

When there is an input from the user (YES at S100), the process proceeds to S110 where the vehicle 100 sends the destination information to the management server 300. As described above, the destination information includes the destination input by the user, SOC, the current position, the estimated time of arrival, the charging request and the like.

Upon receiving the information about the charging station 200 from the management server 300 in response to the destination information sent from the vehicle 100, the vehicle 100 displays the information about the charging station 200 on the screen of the navigation device 170 as illustrated in FIG. 7 (S120). Thereafter, at S130, the vehicle 100 determines whether or not the user has selected one of the displayed candidates of charging stations 200. When there is no selection input from the user (NO at S130), the process of the vehicle 100 returns to S130 and waits for a selection input from the user. Although not illustrated in FIG. 8, if the selection input from the user is not performed for a predetermined time (for example, 10 minutes), or if the screen is switched when no selection input is made, the standby processing at S130 is interrupted and the process is terminated.

When there is a selection input from the user (YES at S130), the process proceeds to S140 where the vehicle 100 sends a charging reservation request to the selected charging station 200 via the management server 300.

When a reservation confirmation message for confirming the charging reservation request is sent from the management server 300, the vehicle 100 displays the reservation confirmation message to the user (S150), and terminates the process thereafter.

Next, the process executed in the management server 300 will be described. At S300, the management server 300 determines whether or not the destination information has been received from the vehicle 100. If the destination information has not been received (NO at S300), the process returns to S300, and the management server 300 waits until the destination information is received from the vehicle 100.

When the destination information has been received (YES at S300), the process proceeds to S310 where the management server 300 selects a number of charging stations 200 as the inquiry target based on the acquired destination information and the map information stored in the memory 320 (FIG. 5). The target charging stations include a charging station 200 installed in the destination and a charging station 200 installed around the destination (for example, within a radius of 5 km). After the charging stations are selected, the management server 300 sends a transmission request for the station information to the selected charging station (S320).

At S330, the management server 300 determines whether or not the station information has been received from each of the selected charging stations. If the station information has not been received from any of the selected charging stations 200 (NO at S330), the process returns to S330 and waits until all of the station information has been received.

On the other hand, when the station information has been received from all of the selected charging stations 200 (YES at S330), the process proceeds to S340. Although not illustrated in FIG. 8, if the station information has not been received from a part of the charging stations after a predetermined time, the processing at S330 is interrupted and the process proceeds to S340. At S340, the management server 300 edits the received station information and sends the edited station information to the vehicle 100. As described with reference to FIG. 6, in the editing process at S340, the information of a charging station 200 installed around the destination may be sent when the congestion degree of the destination is greater than a predetermined threshold value.

Thereafter, upon receiving the charging reservation request from the vehicle 100, the management server 300 sends the charging reservation request to the charging station 200 selected by the user (S350). Then, upon receiving the reservation confirmation message from the charging station 200 selected by the user, the management server 300 sends the received reservation confirmation message to the vehicle 100 (S360), and terminates the process.

Although not illustrated in FIG. 8, if the charging reservation request is not received from the vehicle 100 for a predetermined time (for example, 10 minutes) after sending the station information to the vehicle 100 at S340, the management server 300 skips the subsequent processing at S350 and S360, and terminates the process.

Next, the process executed in the charging station 200 will be described. At S200, the charging station 200 determines whether or not a transmission request for the station information has been received from the management server 300. If the transmission request for the station information is not received (NO at S200), the process returns to S200, and the charging station 200 waits until the transmission request is received from the management server 300.

When the transmission request is received (YES at S200), the process proceeds to S210 where the charging station 200 acquires information such as the congestion information, the reservation information, the waiting time, the incentive information and the like about itself. Then, the charging station 200 sends the acquired station information to the management server 300 (S220).

Thereafter, when the user selects a desired charging station, and the charging reservation request is received from the management server 300, the charging station 200 executes a charging reservation processing of the vehicle 100 at S230. Upon completion of the charging reservation processing, the charging station 200 sends a reservation confirmation message indicating that the reservation has been successfully accepted to the vehicle 100 via the management server 300 (S240), and terminates the process.

Although not illustrated in FIG. 8, if the charging reservation request is not received from the management server 300 for a predetermined time (for example, 15 minutes) after sending the station information to the management server 300 at S220, in other words, if the charging station is not selected by the user, the charging station 200 skips the processing of S230 and S240, and terminates the process.

By controlling the vehicle 100, the charging station 200, and the management server 300 according to the process as described above, when the user of the vehicle 100 designates a destination, the management server 300 informs the user of the congestion information about the charging station installed in the destination and the information about a charging station installed around the destination together with the incentive information. Since the incentive information may increase the possibility that the user may select to charge at a charging station available around the destination, it is possible to alleviate the congestion degree of the destination so as to provide the user an opportunity to charge the vehicle during the period of staying at the destination.

The incentive information for each charging station may be appropriately modified in response to different seasons, different days, different time, the congestion degree of the charging station itself or the like. For example, the discount may not be offered if the charging station itself is congested. Alternatively, the discount rate may be increased so as to further enhance the incentive of the user in a period such as the daytime of a weekday or the like where the number of users is relatively sparse.

Also, a charging station installed around the destination may be selected based on the user's preference. For example, a shop that is frequently visited by a user or a charging station that is offering a discount service suitable for the user's preference may be preferentially selected.

The embodiments disclosed herein are illustrative and non-restrictive in any respect. The technical scope indicated by the claims is intended to include any modifications within the scope and meaning equivalent to the terms of the claims.

What is claimed is:

1. An information providing system comprising:
a plurality of charging stations configured to supply electric power;
a vehicle equipped with a power storage device and configured to charge the power storage device by using the electric power supplied from the charging station; and
a server configured to communicate with the vehicle and the plurality of charging stations,
the vehicle sending information about a destination designated by a user to the server,
upon receiving from the vehicle the information about the destination, the server being configured to acquire congestion information indicating a congestion degree of a charging station installed in the destination from the same charging station among the plurality of charging stations and incentive information for prompting charging at a charging station installed around the destination from the same charging station among the plurality of charging stations, and sending the information to the vehicle,
the vehicle being configured to display the information sent from the server to the user.

2. The information providing system according to claim 1, wherein
the server is configured to send the congestion information and the incentive information to the vehicle when the congestion degree of the charging station installed in the destination is greater than a threshold value.

3. The information providing system according to claim 1, wherein
the incentive information includes information about a discount service provided by the charging station installed around the destination.

4. The information providing system according to claim 3, wherein
the discount service includes a discount on unit price of power or a discount on parking fee.

5. The information providing system according to claim 3, wherein
the charging station installed around the destination includes a charging station installed in a store,
the discount service includes a discount on prices of goods and charges of services provided by the store.

6. The information providing system according to claim 1, wherein
the vehicle is provided with a display configured to display the information from the server, and an input device configured to select a desired charging station from charging station candidates included in the displayed information from the server,
when a desired charging station is selected by the user from the charging station candidates, the vehicle is configured to send information for specifying the selected charging station to the server,
the server is configured to send a charging reservation request to the selected charging station.

7. The information providing system according to claim 6, wherein
the charging reservation request includes information about the vehicle and an estimated time of arrival to the selected charging station,
the selected charging station is configured to process the charging reservation from the vehicle according to the charging reservation request.

8. A method to be used in a system including a plurality of charging stations, a vehicle equipped with a power storage device and a server for providing information about a charging station to a user of the vehicle,
the vehicle and the plurality of charging stations being configured to communicate with the server,
the vehicle being configured to charge the power storage device by using electric power from a charging station,
the method comprising:
causing the server to acquire from the vehicle information about a destination designated by a user's operation on the vehicle;
causing the server to acquire congestion information indicating a congestion degree of a charging station installed in the destination from the same charging station among the plurality of charging stations and incentive information for prompting charging at a charging station installed around the destination from the same charging station among the plurality of charging stations;
causing the server to send the congestion information and the incentive information to the vehicle; and
causing the vehicle to display the information sent from the server to the user.

9. A server configured to communicate with a vehicle equipped with a power storage device and a plurality of charging stations, and provide information about a charging station to a user of the vehicle,
the server being configured to
acquire information about a destination designated by a user's operation on the vehicle,
acquire congestion information indicating a congestion degree of a charging station installed in the destination from the same charging station among the plurality of charging stations and incentive information for prompting charging at a charging station installed around the destination from the same charging station among the plurality of charging stations, and
send the congestion information and the incentive information to the vehicle so as to be displayed to the user.
